(19) United States
(12) Patent Application Publication
(10) Pub. No.: US 2013/0074795 A1
(43) Pub. Date: Mar. 28, 2013

(54) METHOD FOR CONTROLLING AN AUTOMATIC START-STOP MECHANISM

(71) Applicant: GM GLOBAL TECHNOLOGY OPERATIONS LLC, Detroit, MI (US)

(72) Inventors: Alexander MICHEL, Rheinboellen (DE); Gerhard LANDSMANN, Roedern (DE)

(73) Assignee: GM GLOBAL TECHNOLOGY OPERATIONS LLC, Detroit, MI (US)

(21) Appl. No.: 13/623,577

(22) Filed: Sep. 20, 2012

(30) Foreign Application Priority Data
Sep. 21, 2011 (DE) 10 2011 113 926.9

(51) Int. Cl. F02D 41/04; F02N 11/08

(52) U.S. Cl. 123/179.4; 701/112

(57) ABSTRACT

One aspect of the present disclosure relates to a method for controlling an automatic start-stop mechanism for an internal combustion engine. The method comprises providing a turbocharger temperature, comparing the turbocharger temperature with a constant and, if the turbocharger temperature is greater than the constant, deactivating the automatic start-stop mechanism of the internal combustion engine.

### CROSS-REFERENCE TO RELATED APPLICATION

This application claims priority to German Patent Application No. 10 2011 113 926.9, filed Sep. 21, 2011, which is incorporated herein by reference in its entirety.

### TECHNICAL FIELD

The technical field relates to a method for controlling an automatic start-stop mechanism of an energy conversion machine, in particular an internal combustion engine.

### BACKGROUND

In vehicles with an automatic start-stop mechanism, the internal combustion engine is switched off when standing in order to save fuel. Internal combustion engines usually have a cooling circuit in which water circulates and releases heat to a heat exchanger. In addition, engine oil circulates in the internal combustion engines themselves, which oil also removes heat from thermally stressed regions. As long as the internal combustion engine is running, the water or the engine oil is circulated and the heat produced therein can always be removed. Thus, it may be desirable that after high stressing, the internal combustion engine be allowed to run for a while when standing so that the heat from thermally particularly stressed components such as, for example, turbochargers can be removed.

In addition, other objects, desirable features and characteristics will become apparent from the subsequent summary and detailed description, and the appended claims, taken in conjunction with the accompanying drawings and this background.

### SUMMARY

According to various aspects of the present disclosure, provided is a method for regulating an internal combustion engine with which too high thermal stressing of the internal combustion engine can be reliably avoided.

According to one of various aspects of the present disclosure, a method for controlling an automatic start-stop mechanism for an internal combustion engine is provided, comprising:

a) providing a turbocharger temperature,

b) comparing the turbocharger temperature with a constant and,

c) if the turbocharger temperature is greater than the constant, deactivating the automatic start-stop mechanism of the internal combustion engine.

The motor is therefore generally deactivated when the turbocharger temperature is lower than the constant which corresponds to a maximum permissible temperature for the turbocharger. A critical temperature limit in which engine oil in the turbocharger would be heated by heat transfer from hot parts of the turbocharger may thereby be avoided. In turbochargers a compressor and a turbine are rotatably mounted on an axis. High engine oil temperatures lead to an increased aging of the oil. The engine oil could form vapor bubbles and displace liquid components of the engine oil from the mounting. When restarting the internal combustion engine and therefore the turbocharger, this could result in mixed friction in the bearing that is a direct friction between parts to be mounted, not carried by engine oil. Mixed friction usually leads to an increased bearing wear. In one example, the bearing wear is avoided by deactivating the automatic start-stop mechanism when the turbocharger is too hot.

According to one of various exemplary embodiments, the turbocharger temperature is measured by means of a temperature sensor disposed on the turbocharger. In this example, a precise temperature can be determined directly which can be considered to be noncritical for the turbocharger and set as a constant for the comparison. For example, a temperature at which the engine oil begins to form vapor bubbles under normal conditions can be used.

According to one of various exemplary embodiments, the turbocharger temperature is modeled from engine parameters correlating with the turbocharger temperature. The modeling can be based on empirically determined data on comparative engines or by simulations. The turbocharger temperature can thus be deduced from the engine parameters with the result that a direction detection of the turbocharger temperature by a sensor provided for this purpose can be omitted.

According to a further one of various exemplary embodiments which can supplement the last-mentioned exemplary embodiment, an operating temperature since the last stoppage of the internal combustion engine is used to determine a modeled turbocharger temperature. It is assumed in this case that during longer operation of the internal combustion engine, for example, on longer freeway journeys, the turbocharger temperature will be correspondingly high.

According to a further one of various exemplary embodiments, a position of the gas pedal is used to determine a modeled turbocharger temperature. This can take place in addition to determining the operating time. Through the gas pedal position the driver predefines a power delivered by the internal combustion engine or a delivered torque. An increased power requirement leads to higher thermal losses and therefore also to hot engine conditions. If the internal combustion engine was operated at a higher gas pedal position, it should be assumed that the internal combustion engine is run correspondingly hot and the internal combustion engine should not be switched off straight away.

According to another, alternative or additional exemplary embodiment, a vehicle speed is used to determine a modeled turbocharger temperature. At increased vehicle speeds, the internal combustion engine must apply more power Immediately after driving at high speeds, it can therefore also be assumed that the turbocharger temperature is very high. Using the vehicle speed has the advantage of the availability of a corresponding electronic signal in each vehicle; the method can therefore be implemented with relatively simple means.

According to another likewise alternative or additional exemplary embodiment, an engine oil temperature of engine oil present in the internal combustion engine is used to determine a modeled turbocharger temperature. The engine oil can be the same engine oil which lubricates the mounting of the turbocharger and removes heat therefrom during operation. With a hot turbocharger, the engine oil temperature will accordingly also be high.

According to one of various exemplary embodiments, a cooling water temperature of cooling water circulating in the internal combustion engine during operation is measured to determine a modeled turbocharger temperature. At high cooling water temperatures it is overwhelmingly possible that the internal combustion engine has been operated at an increased load. At high cooling water temperatures it can thus be assumed that the turbocharger temperature is increased.

The method described and the advantageous embodiments can be provided in a drive train of a motor vehicle, in particular in a control unit.

The control unit can have a digital microprocessor unit (CPU) data-connected to a storage system and a bus system, a random access memory (RAM) and a memory means. The CPU is configured to process commands which are executed as a program stored in a memory means, to record input signals from the data bus, and deliver output signals to the data bus. The storage system can have various storage media such as optical, magnetic, solid and other non-volatile media on which a corresponding computer program is stored for executing the method and the advantageous embodiments. The program can be constituted in such a manner that it embodies or is able to execute the methods described here so that the CPU can execute the steps of such methods and can thereby control the motor vehicle.

A computer program which has program code means is suitable for executing a method in order to carry out all the steps of any one of the exemplary embodiments when the program is executed on a computer.

The computer program can have program code means in order to execute all the steps of the method and optionally additional exemplary configurations contained herein when the program is executed on a computer. The computer program can be read into already existing control unit by simple means and used in order to control an automatic start-stop mechanism.

A computer program product with program code means which are stored on a computer-readable data carrier is provided for this purpose in order to carry out the method described herein when the program product is executed on a computer. The computer program product can also be integrated as a retrofitting option in control units.

A further aspect according to the various teachings of the present disclosure relates to an apparatus for controlling an automatic start-stop mechanism for an internal combustion engine comprising:

a) means for providing a turbocharger temperature,

b) means for comparing the turbocharger temperature with a constant, and

c) means for deactivating the automatic start-stop mechanism of the internal combustion engine if the turbocharger temperature is greater than the constant.

A critical temperature limit at which engine oil in the turbocharger would be severely heated by heat transfer from hot parts of the turbocharger is thereby avoided.

In one exemplary embodiment of the apparatus the means for providing a turbocharger temperature are further configured to measure the turbocharger temperature by means of a temperature sensor disposed on a turbocharger.

In a further exemplary embodiment of the apparatus the means for providing a turbocharger temperature are configured to model the turbocharger temperature from engine parameters correlating with the turbocharger temperature. A direct recording of the turbocharger temperature by a sensor provided for this purpose and therefore the sensor itself can therefore be omitted.

In one of various exemplary embodiments of the apparatus the means in the preceding paragraph are configured to use an operating time since the last stoppage of the internal combustion engine to determine a modeled turbocharger temperature.

When a longer operating time was recorded, it can be assumed that the internal combustion engine is run correspondingly hot and the internal combustion engine should not be switched off straight away.

One of various exemplary embodiments of the apparatus comprises that the means of the last but one paragraph are configured to use a position of a gas pedal to determine a modeled turbocharger temperature.

If the internal combustion engine was operated at a higher gas pedal position, it can be assumed that the internal combustion engine is run correspondingly hot and the internal combustion engine should not be switched off straight away.

In a further one of various exemplary embodiments of the apparatus, the means for providing a turbocharger temperature are configured to use a vehicle speed to determine a modeled turbocharger temperature.

At increased vehicle speeds, the internal combustion engine must apply more power. Directly after driving at high speeds, it can thus also be assumed that the turbocharger temperature will be high. Use of the vehicle speed has the advantage of the availability of a corresponding electronic signal in each vehicle, so that the method can be implemented with relatively simple means.

A further one of various exemplary embodiments of the apparatus comprises that the means for providing a turbocharger temperature are configured to use an engine oil temperature of an engine oil present in the internal combustion engine to determine this temperature. This is because it can be assumed that with a hot turbocharger the engine oil temperature will also be high.

Another one of various exemplary embodiments of the apparatus comprises that the means for providing a turbocharger temperature are configured to measure a cooling water temperature of cooling water circulating in the internal combustion engine during operation to determine this temperature.

At high cooling water temperatures it can thus be assumed that the turbocharger temperature will be increased.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows in a schematic view an outline of an internal combustion engine with a turbocharger; and

FIG. 2 shows in a schematic block diagram one possible method for deactivating an automatic start-stop mechanism under certain operating conditions.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

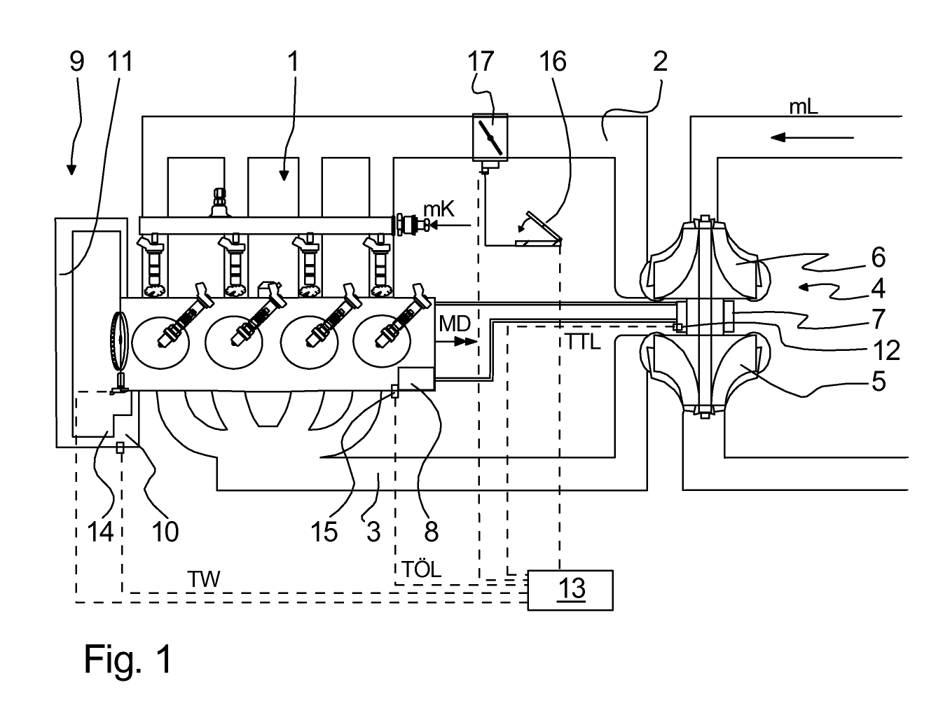

FIG. 1 shows an internal combustion engine 1 with an intake channel 2 and an exhaust gas channel 3. The internal combustion engine 1 is suitable as a drive of a vehicle not shown. Air mass mL is passed into the internal combustion engine 1 through the intake channel 2. Combustion air is discharged again through the exhaust gas channel 3. The exhaust gas enters into a turbocharger 4, which comprises a turbine 5 and a compressor 6. The turbocharger 4 has a mounting 7 which is operated with engine oil from the internal combustion engine. The engine oil thereby removes heat from the turbocharger 4. The engine oil is conveyed by an oil pump 8. The internal combustion engine 1 additionally has a cooling circuit 9 in which a cooling medium (usually water with frost protection agents) circulates. The cooling medium is conveyed by a water pump 10.

During operation of the internal combustion engine 1, heat is produced in the internal combustion engine 1 and in the turbocharger 4, which can be released via the cooling circuit 9 to a cooler 11. A further heat fraction is removed by the exhaust gas. The turbocharger 4 is cooled at least by the engine oil. As long as the internal combustion engine 1 is running, and the oil pump 8 and the water pump 10 are operating, the heat produced can be removed from the internal combustion engine 1 and the turbocharger 4. If, on the other hand, the internal combustion engine 1 is deactivated, heated components deliver their heat by convection to the sometimes stationary engine oil or cooling medium. As a result, the aging process of the engine oil can be accelerated and the engine oil can form vapor bubbles or resinify. Depositions can form in the mounting 7, which can adversely affect the bearing properties. In addition, vapor bubbles can displace the engine oil from the mounting. A temperature sensor 12 is disposed directly on the turbocharger 4, which is configured to directly measure a turbocharger temperature TTL and relay this to a control unit 13. In addition, a water temperature sensor 14 is disposed on the water pump 10. This is connected by signal technology to the control unit 13 and relays a water temperature TW to the control unit 13.

The control unit 13 comprises a microprocessor, a random access memory (RAM) and a storage means, for example, a flash memory, for storing a computer program. During execution of the program code means of the computer program by the microprocessor, the internal combustion engine 1 is controlled by means of the logic of the algorithm forming the basis of the computer program. The dashed lines emanating from the control unit 13 show the components with which the control unit 13 communicates via its inlet or outlet ports.

Furthermore, the internal combustion engine 1 has an oil temperature sensor 15, which senses the engine oil temperature TÖL in the internal combustion engine. This is also connected to the control unit 13 by signal technology. The internal combustion engine 1 or a torque output from it is regulated inter alia via a gas pedal 16. The control unit 13 is configured to detect a position of the gas pedal by signal technology. The control unit 13 is configured to deactivate the internal combustion engine 1 under certain operating conditions, for example, when the vehicle is stopped, when no gear selection is made or a clutch pedal not shown is actuated. This function is designated as automatic start-stop mechanism. In this way the fuel consumption of the internal combustion engine 1 can be reduced, since longer idling phases are avoided. In addition, the control unit 13 can record engine parameters such as, for example, an operating time since the last stoppage.

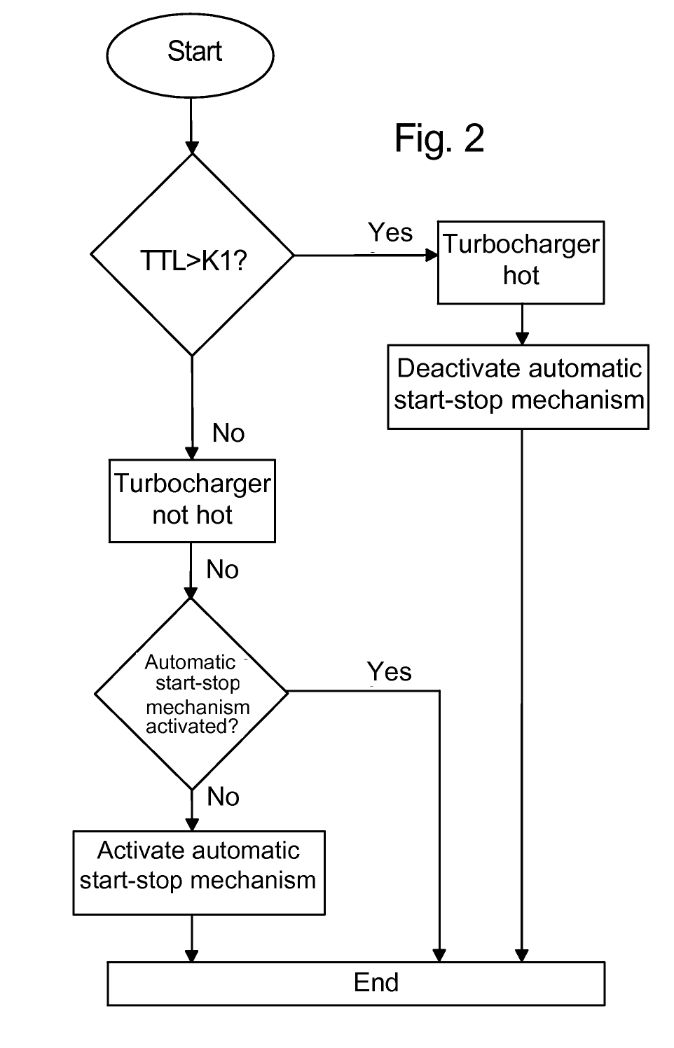

The control unit 13 is further configured to execute a method according to FIG. 2. The method provides that the internal combustion engine 1 is not deactivated if the turbocharger 4 is too hot. After starting it is determined in a first step how high the turbocharger temperature TTL is. This can be accomplished directly via the temperature sensor 12. Alternatively the turbocharger temperature TTL is merely modeled from engine parameters. Several parameters come into consideration for this, which correlate with the turbocharger temperature TTL. For example, it is possible to use the vehicle speed at which the vehicle was last operated, that is directly before the start of the method. Furthermore, the position of the gas pedal 16 or an engine speed detected at a speed sensor 18 can be used. If the internal combustion engine 1 comprises an Otto engine, a position of a throttle valve 17 can also be used to model the turbocharger temperature TTL. In diesel engines a transducer of an injection device for fuel can be used. Numerous subcombinations of the engine parameters described can be used for the modeling. It is merely important that the engine parameters correlate with an increased turbocharger temperature TTL so that an injected amount of fuel mK over a certain time interval, an air mass flow mL or even a measured or modeled engine torque MD come into consideration. In the presence of increased values for one or more engine parameters, accordingly the delivered power and therefore the thermal loading is correspondingly higher and the turbocharger temperature TTL is increased.

The turbocharger temperature TTL provided by measurement or modeling is compared with a constant K1. If the turbocharger temperature TTL is lower than the constant K1, the answer is “no” and the automatic start-stop mechanism can be activated. If appropriate conditions exist the internal combustion engine 1 is therefore temporarily switched off. Activation of the automatic start-stop mechanism is checked in a next step. If it is not activated, the answer is “no.” The automatic start-stop mechanism is activated (again), the program is ended and it begins again at “start.” If the answer is “yes”, the program is ended and it begins again. If the vehicle is therefore standing for a fairly long time, the turbocharger 4 can initially be cooled before the automatic start-stop mechanism is activated again.

If the turbocharger temperature TTL is greater than the constant K1, the answer in the first process step after the start is “yes.” The turbocharger is hot and the automatic start-stop mechanism is deactivated, after which the process is ended and carried out again.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for controlling an automatic start-stop mechanism for an internal combustion engine, comprising:
providing a turbocharger temperature;
comparing the turbocharger temperature with a constant; and
if the turbocharger temperature is greater than the constant, deactivating the automatic start-stop mechanism of the internal combustion engine.

2. The method according to claim 1, wherein the turbocharger temperature is measured by means of a temperature sensor disposed on a turbocharger.

3. The method according to claim 1, wherein the turbocharger temperature is modeled from engine parameters correlating with the turbocharger temperature.

4. The method according to claim 3, wherein an operating time since the last stoppage of the internal combustion engine is used to determine a modeled turbocharger temperature.

5. The method according to claim 3, wherein a position of a gas pedal is used to determine a modeled turbocharger temperature.

6. The method according to claim 3, wherein a vehicle speed is used to determine a modeled turbocharger temperature.

7. The method according to claim 3, wherein an engine oil temperature of an engine oil present in the internal combustion engine is used to determine a modeled turbocharger temperature.

8. The method according to claim 3, wherein a cooling water temperature of cooling water circulating in the internal combustion engine during operation is measured to determine a modeled turbocharger temperature.

9. A motor vehicle, comprising:
a turbocharger;
an internal combustion engine having an automatic start-stop mechanism;
a control unit having a non-transitory storage means with a computer program product stored thereon, wherein the computer program product is configured to:
determine a turbocharger temperature;
compare the turbocharger temperature with a constant; and
deactivate the automatic start-stop mechanism of the internal combustion engine if the turbocharger temperature is greater than the constant.

10. A computer program product for processing a signal, comprising:
a tangible storage means readable by a processor and storing instructions for execution by the processor for performing a method comprising:
providing a turbocharger temperature;
comparing the turbocharger temperature with a constant; and
if the turbocharger temperature is greater than the constant, deactivating an automatic start-stop mechanism of an internal combustion engine.

11. The computer program product according to claim 10, wherein providing a turbocharger temperature further comprises:
measuring the turbocharger temperature using a temperature sensor disposed on a turbocharger.

12. The computer program product according to claim 10, wherein providing a turbocharger temperature further comprises:
modeling the turbocharger temperature from engine parameters correlating with the turbocharger temperature.

13. The computer program product according to claim 12, wherein modeling the turbocharger temperature further comprises:
determining an operating time since the last stoppage of the internal combustion engine; and
modeling the turbocharger temperature based on the last stoppage of the internal combustion engine.

14. The computer program product according to claim 12, wherein modeling the turbocharger temperature further comprises:
determining a position of a gas pedal; and
modeling the turbocharger temperature based on the position of the gas pedal.

15. The computer program product according to claim 12, wherein modeling the turbocharger temperature further comprises:
determining a vehicle speed; and
modeling the turbocharger temperature based on the vehicle speed.

16. The computer program product according to claim 12, wherein modeling the turbocharger temperature further comprises:
determining an engine oil temperature of an engine oil present in the internal combustion engine; and
modeling the turbocharger temperature based on the engine oil temperature.

17. The computer program product according to claim 12, wherein modeling the turbocharger temperature further comprises:
determining a cooling water temperature of cooling water circulating in the internal combustion engine during operation; and
modeling the turbocharger temperature based on the cooling water temperature.
